(19) United States
(12) Patent Application Publication
(10) Pub. No.: US 2014/0051446 A1
(43) Pub. Date: Feb. 20, 2014

(54) Saving Energy in Multi-RAT Communication Network

(71) Applicants: Dirk Rose, Munich (DE); Jurgen Michel, Munich (DE)

(72) Inventors: Dirk Rose, Munich (DE); Jurgen Michel, Munich (DE)

(73) Assignee: NOKIA SIEMENS NETWORKS OY, ESPOO (FI)

(21) Appl. No.: 14/114,232

(22) PCT Filed: May 12, 2011
(86) PCT No.: PCT/EP11/57710

§ 371 Date: Oct. 28, 2013

(51) Int. Cl. H04W 36/16

(52) U.S. Cl. CPC H04W 36/165
USPC 455/436

(57) ABSTRACT

There is provided amongst others an embodiment according to which an eNB detects a predetermined condition that allows for an energy saving procedure to be applied, wherein the energy saving procedure includes switching off at least one cell of a first radio access technology, performs a first handover of at least one user terminal from the first radio access technology to a second radio access technology, temporarily switches off the at least one cell of the first radio access technology after the first handover is completed, and allocates resources of the first radio access technology to at least one of the at least one user terminal which is handed back from the second radio access technology to the first radio access technology in a second handover, wherein radio access coverage for the first radio access technology is provided by the at least one cell which has not been switched off.

### FIELD

The invention relates generally to mobile communication networks. More particularly, the invention relates to saving energy in the mobile communication networks.

### BACKGROUND

In radio communication networks, such as the Long Term Evolution (LTE) or the LTE-Advanced (LTE-A) of the 3^{rd} Generation Partnership Project (3GPP), network planning comprises the use of base stations, such as radio network controllers (RNC), Node Bs (NB), and/or evolved NBs, (eNB). It is common to have the base stations located densely in order to support high traffic scenarios. However, during night times, or in general during times of low traffic, there is no need to have each of the base stations on and consume power. Therefore, it has been proposed to switch certain base stations off during the low-traffic periods in order to optimize energy consumption. This may be seen to correspond to inter-eNB energy saving (ES) procedure.

However, several problems are related to this type of energy saving. The problems relate to timing of the transition from the normal mode (state) to the energy saving mode, to coverage requirements, to degraded quality-of-service (QoS), etc. Thus, it is important to provide a solution for more efficiently, more user-friendly and more reliably apply the energy saving procedures in a radio communication network.

### BRIEF DESCRIPTION OF THE INVENTION

Embodiments of the invention seek to improve the energy saving in a radio communication network.

According to an aspect of the invention, there are provided methods as specified in claims 1 and 8.

According to an aspect of the invention, there are provided apparatuses as specified in claims 10, 17, and 19.

According to an aspect of the invention, there are provided computer program products as specified in claims 20.

According to an aspect of the invention, there is provided an apparatus comprising: means for detecting a predetermined condition that allows for an energy saving procedure to be applied, wherein the energy saving procedure comprises switching off at least one cell of a first radio access technology; means for performing a first handover of at least one user terminal from the first radio access technology to a second radio access technology; means for temporarily switching off the at least one cell of the first radio access technology after the first handover is completed; and means for allocating resources of the first radio access technology to at least one of the at least one user terminal which is handed back from the second radio access technology to the first radio access technology in a second handover, wherein radio access coverage for the first radio access technology is provided by the at least one cell which has not been switched off.

In an embodiment, the apparatus may further comprise means for adapting, before the second handover is performed, the at least one cell of the first radio access technology which has not been switched off in order to provide radio access coverage to the area of the cells that have been switched off, wherein the adapting comprises changing at least one of the following: transmission power, tilt angle and azimuth angle. The apparatus may further comprise means for enquiring the second radio access technology if it is capable of allocating resources to the at least one user terminal which is handed over in the first handover, and means for performing the first handover after the second radio access technology has confirmed its capability. The apparatus may further comprise means for receiving information from the second radio access technology regarding the success of the second handover, and means for applying the received information in determining configuration of the following energy saving procedure. The apparatus may further comprise means for applying the knowledge of at least one of the following in the configuration of the following energy saving procedure: the number of handover between the first and the second radio access technology during the current energy saving procedure, and information from the second radio access technology regarding the coverage of the first radio access technology during the current energy saving procedure. The apparatus may further comprise means for performing a further handover of certain at least one user terminal from the first radio access technology to the second radio access technology when the coverage of the first radio access technology during the energy saving procedure is insufficient for the certain at least one user terminal.

According to yet another aspect of the invention, there is provided an apparatus comprising: means for allocating resources of a second radio access technology to at least one user terminal which is handed from a first radio access technology over to the second radio access technology before at least one cell of the first radio access technology is temporarily switched off in order to apply an energy saving procedure in the first radio access technology; means for performing a second handover of at least one of the at least one user terminal from the second radio access technology to the first radio access technology after the at least one cell of the first radio access technology is temporarily switched off; and means for providing information to the first radio access technology regarding the success of the second handover.

In an embodiment, the apparatus may further comprise means for providing further information regarding the coverage of the first radio access technology during the energy saving procedure.

Further embodiments of the invention are defined in the dependent claims.

### LIST OF DRAWINGS

In the following, the invention will be described in greater detail with reference to the embodiments and the accompanying drawings, in which

FIGS. 1A and 1B present a communication network applying an inter-eNB energy saving procedure;

FIG. 2 shows a communication network applying an inter-RAT energy saving procedure;

FIGS. 3A and 3B show communication networks according to embodiments;

FIG. 4 illustrates an apparatus according to embodiments;

FIG. 5 illustrates a signaling flow diagram according to an embodiment; and

FIGS. 6 and 7 illustrate methods according to embodiments.

### DESCRIPTION OF EMBODIMENTS

The following embodiments are exemplary. Although the specification may refer to “an”, “one”, or “some” embodiment(s) in several locations of the text, this does not necessarily mean that each reference is made to the same embodiment(s), or that a particular feature only applies to a single embodiment. Single features of different embodiments may also be combined to provide other embodiments. Radio communication networks, such as the Long Term Evolution (LTE) or the LTE-Advanced (LTE-A) of the 3^{rd} Generation Partnership Project (3GPP), are typically composed of at least one base station (also called a base transceiver station, a radio network controller, a Node B, or an evolved Node B, for example), at least one user equipment (UE) (also called a user terminal, terminal device or a mobile station, for example) and optional network elements that provide the interconnection towards the core network. The base station connects the UEs via the so-called radio interface to the network. The base station may provide radio coverage to a cell, control radio resource allocation, perform data and control signaling, etc. The cell may be a macrocell, a microcell, or any other type of cell where radio coverage is present.

In general, a base station may be configured to provide communication services according to at least one of the following radio access technologies (RATs): Worldwide Interoperability for Microwave Access (WiMAX), Global System for Mobile communications (GSM, 2G), GSM EDGE radio access Network (GERAN), General Packet Radio Service (GRPS), Universal Mobile Telecommunication System (UMTS, 3G) based on basic wideband-code division multiple access (W-CDMA), high-speed packet access (HSPA), LTE, and/or LTE-A. The present embodiments are not, however, limited to these protocols.

The base station may be node B (NB) as in the LTE, evolved node B (eNB) as in the LTE-A, a radio network controller (RNC) as in the UMTS, a base station controller (BSC) as in the GSM/GERAN, or any other apparatus capable of controlling radio communication and managing radio resources within the cell. The base station may also have an effect on mobility management by controlling and analyzing radio signal level measurements performed by a user terminal, carrying out its own measurements and performing handovers of user terminals. The handovers may be performed to hand over user terminals from one base station to another. This may comprise handovers within one radio access technology (intra-RAT) or handovers between different RATs (inter-RAT).

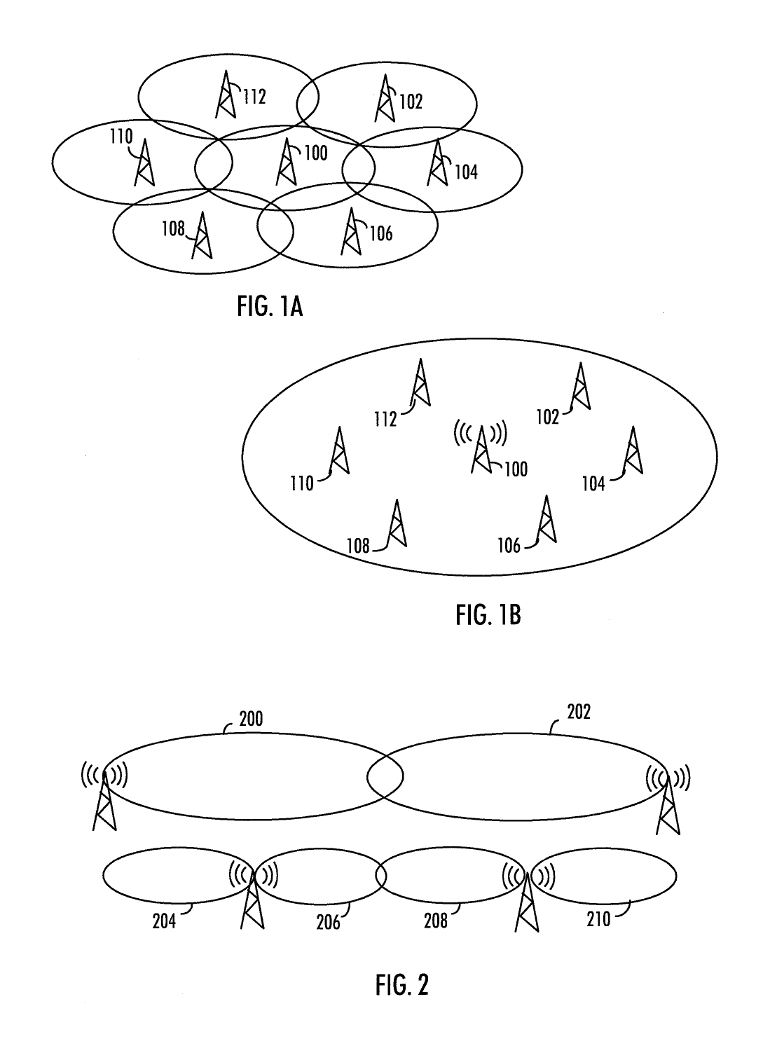

In current approaches, energy saving may be performed by either with an inter-eNB or by an inter-RAT ES procedures. For inter-eNB, an exemplary scenario is characterized by a single layer (single frequency) of E-UTRAN cells, wherein the E-UTRAN (evolved universal mobile telecommunication's system (UMTS) terrestrial radio access network) is the air interface of the LTE. The scenario is depicted in FIG. 1A, from which it can be seen that the density of the cells provided by the plurality of eNBs is higher than what would be required for pure coverage. This increased density may be needed for capacity reasons during times of high load (e.g. during daytime or a busy hour). Thus, such a scenario may be referred as “capacity limited”. During the “normal” traffic load (non-ES) periods, as shown in FIG. 1A, all eNBs/cells 100 to 112 are switched on and thus each eNB 100 to 112 provides radio access coverage to the corresponding cell. In this exemplary scenario, the energy saving (ES) potential is obtained during low load periods (e.g. during a night) when some cells may be switched off. This is shown in FIG. 1B where only the eNB 100 is providing coverage and the eNBs 102 to 112 may be switched off. During these low-load (ES) periods, the basic coverage to the area is thus provided by the eNB 100, which may also be called an ES compensation eNB/cell, i.e. eNB/cell which is not switched off. Naturally, there may be more than one compensation node but for the reasons of simplicity only one is depicted in FIG. 1. To prepare cell 100 for ES compensation, further adaptations such as reduced down tilt, change in azimuth angle, power increase etc. might be needed in order to increase the coverage and serve areas of ES-cells 102 to 112 (switched-off eNBs/cells).

However, there are drawbacks with the scenario described. One issue is that it is difficult and expensive to ensure that the coverage situation is still good enough in the ES case. This is especially challenging when a large proportion of existing eNBs is switched off to save a lot of energy. For example, with only 20% to 25% of the eNBs are responsible of providing coverage to a large area. Further, the transition from the normal mode (=no-ES mode) to the ES mode and vice versa is cumbersome. In particular it is not clear how the exact timing can be managed. This is because in order to increase the coverage, the ES compensating cells may need to perform adaptations. For example, the tilt may need to be changed (for example by reducing the down tilt) and/or even the transmit power may be increased. If this is done before the neighbors are switched off, interference problems may be created as the other cells may operate in the same frequency. That obviously may lead to QoS problems, radio link failures (RLF) and call drops (CDR). Another approach is to switch off first and then start the adaptations. However, in this case coverage problems during the transition phase may lead to similar effects. Synchronization of the actions has been proposed to solve the timing related problems. However, idle and connected UEs rely on measurements of the neighbor cells signal strength and/or quality (RSRP and RSRQ) in order to support mobility. Thus, if the coverage of the ES compensating cell is small in normal (non-ES) mode, several UEs will not detect the ES compensating cell's signal at all. This means that for the connected UEs no handover can be prepared and for the idle UEs no cell-reselection can be started. Again this results in severe QoS problems, e.g. RLFs, CDRs, throughput degradation, low voice quality, temporarily outage, missed paging.

Another energy saving procedure is the inter-RAT ES procedure. In this scenario, as depicted in FIG. 2, one RAT is present in a same geographical area as another RAT. The missing cell coverage may be provided by another RAT (e.g. 2G, 3G in case LTE is in the ES mode). In the exemplary scenario as shown in FIG. 2, the GSM or UMTS cells 200 to 202 are present in the same area as the LTE cells 204 to 210. In radio communication network, some of the main requirements are to ensure coverage and accessibility. Furthermore, the QoS and the grade of service (GoS) shall not be impaired. In this sense, some of the overlapping cells are not always needed as the inter-RAT neighbors can provide the required QoS, GoS, and coverage during the low traffic load periods. During high load periods the capacity demand is higher and all goes back to “normal” mode, i.e. the non-ES mode is configured on. In principle, the inter-RAT scenario offers high potential for ES. The coverage footprint overlap exists in large parts of the network. Normally the daily variations of traffic are high, i.e. the full capacity is needed during day, but only a small percentage is required during night. This leads to the fact that the load/capacity situation most probably allows for switching off and to serve the requests by the remaining (inter-RAT) cells. However, there are issues that prevent the optimal use of such inter-RAT ES scheme. One issue is the QoS concerns, e.g. GPRS/EDGE or even UMTS/HSPA based cells may not have the capabilities to provide sufficient performance for high demanding service requests of operators not willing to accept that their subscribers pay for the LTE and receive “only” 2G/3G during night. Secondly, UE capability limitations may be of an issue when a great deal of UEs will not be multi-RAT (2G, 3G, LTE)-capable. In detail, 2G-only UEs will exist for a long period. Additionally there might be 3G-only devices without any 2G or LTE capabilities. Finally, LTE-only UEs could be present in the networks and need to be considered in inter-RAT ES scenarios and may thus inhibit an inter-RAT ES usage.

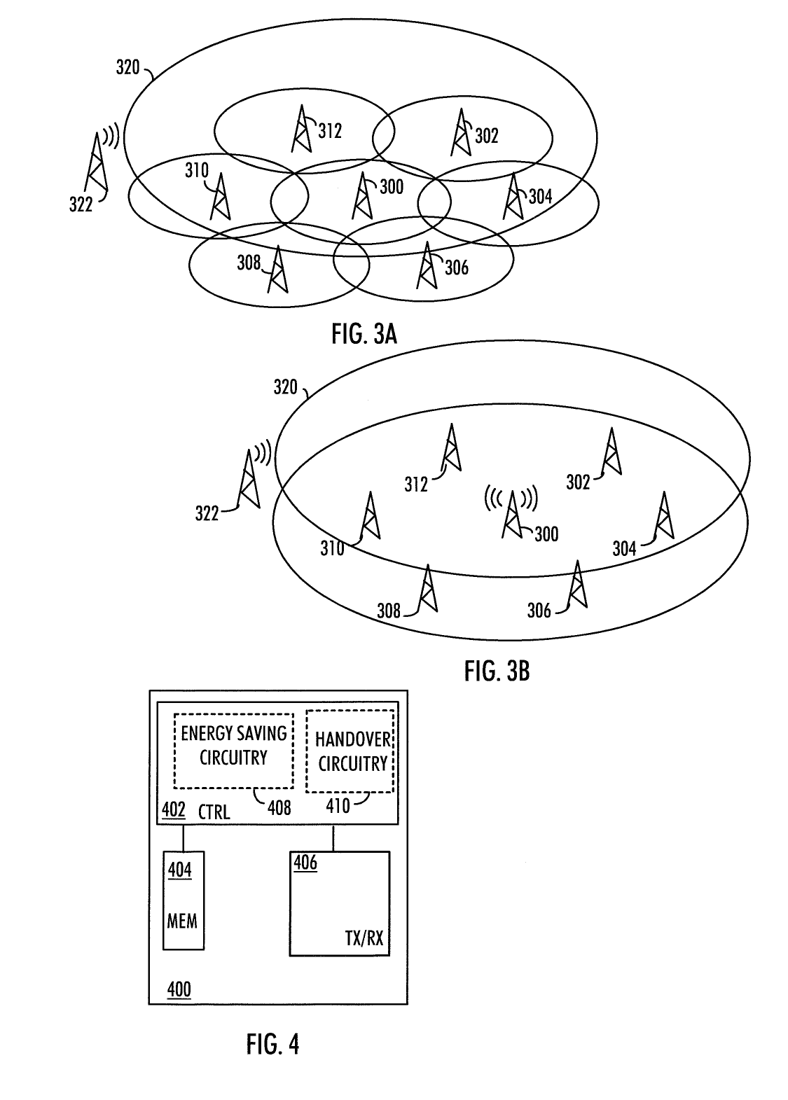

In order to tackle these drawbacks, it is proposed to apply a hybrid ES procedure, where “hybrid” means to combine the inter-eNB and the inter-RAT ES procedures and to enable tight interworking between the RATs in order to coordinate the ES procedures and to improve the performance of the overall network while maintaining basic coverage of all RATs. In this light, the coexistence and co-operations of several different RATs may be considered as one network rather than as individual networks. FIG. 3A depicts this scenario, where a first RAT is provided with a plurality of eNBs 300 to 312, in case of the LTE being the first RAT. A second RAT is provided with one cell 320. The second RAT may be GSM or UMTS, for example. Substantially the same geographical area as of the first RAT is covered also with the second RAT. FIG. 3A depicts a no-ES mode where each eNB/base station 300 to 312 and 322 is providing coverage to respective cells. FIG. 3B then shows the ES mode on wherein radio coverage to the first RAT is provided by only the compensation eNB/cell 300 while the other eNBS/cells 302 to 312 are switched off. The coverage to the second RAT is still being provided by the base station 322.

It is assumed that the inter-RAT neighbors, such as the LTE 300 to 312 and the UMTS 320 in FIGS. 3A and 3B, are deployed for providing backup during the above described transition phase (the time where the intra-RAT radio layer performance is rough due to base station adaptation and switching off of some cells), and for a redundancy measure in order to tackle the coverage uncertainties, such as in order to avoid the risk of coverage holes in the ES mode. The redundancy measure is beneficial so that RLF and CDR and further problems as mentioned earlier are minimized during the ES mode. Further having a backup coverage of another (second) RAT, such as the UMTS, may limit the worst case to a temporarily increased number of inter-system handovers, which is much less severe than any RLF/CDR increase. Therefore, the proposed solution significantly improves the reliability of the ES procedure in terms of QoS, RLF and CDR. As will be explained later, such phenomena of increased inter-RAT mobility (increased handovers) may be detected and may be used in optimizing the ES mode for the future ES on-periods. The existence of another RAT, which may be utilized in the ES mode of the current RAT, may be known by the current RAT by means of network signaling, knowledge on network structures and topologies, pre-configured information in the eNB, etc.

It is proposed that the compensating eNB/cell of a first radio access technology (RAT), which may apply the energy saving procedure, detects a predetermined condition that allows for the energy saving procedure to be applied, wherein the energy saving procedure comprises switching off at least one cell of the first RAT. Thereafter, a first handover of at least one user terminal from the first RAT to a second RAT may be performed. Subsequently, the at least one cell of the first RAT may be temporarily switched off after the handover is completed. This ensures that the CDR and RLF are significantly reduced. Thereafter, resources of the first RAT may be allocated to at least one of the at least one user terminal which is handed back from the second RAT to the first RAT in a second handover, wherein radio access coverage for the first RAT is provided by the at least one cell which has not been switched off. Thus, the second RAT is used as a temporal transition point to protect UEs from connection problems during the phase when the first RAT is changed from the no-ES mode to the ES mode. Therefore, it is for the purposes of the ES mode of the first RAT why the handovers from the first RAT to the second RAT, and vice versa, are needed and performed. According to the proposal some cells of a particular RAT (or even several RATs) can be completely powered off. The remaining cells of the particular RAT(s) and/or the other inter-RAT cells are employed as compensation. In other words, during ES periods these remaining compensation cells provide users with a sufficient service in respect to coverage, GoS and QoS requirements. The tight interworking between the RATs enhances the information exchange between the controlling nodes in order to co-ordinate ES procedure and assure sufficient coverage.

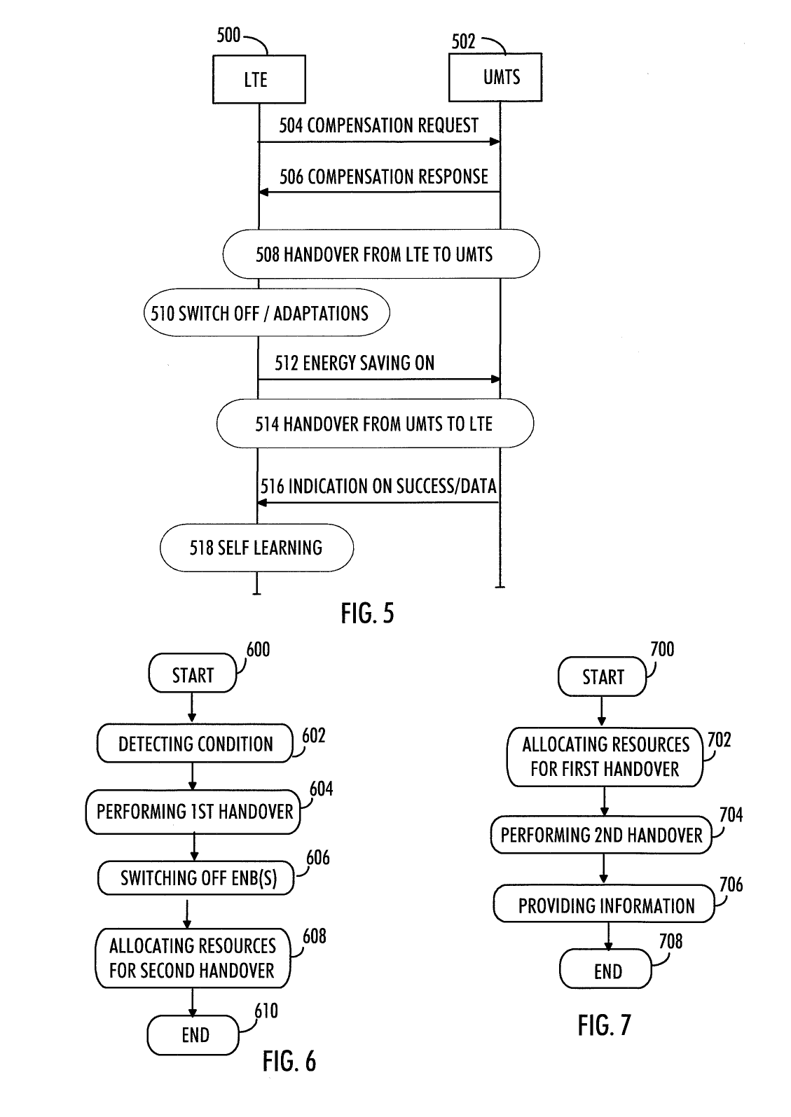

Let us take a more detailed look on the proposed procedure with reference to FIG. 5. In FIG. 5, the first radio access technology is assumed to be the LTE 500 and the second radio access technology is assumed to be the UMTS (UTRAN) 502. In this case, the communication terminating points in the signaling procedure may be an eNB in the LTE 500 and a RNC in the UMTS 502. Alternatively, operation and maintenance unit (O&M) may take care of the signaling between the first and the second RAT 500 and 502, respectively. For the sake of simplicity, let us assume in the following description that the eNB of the LTE 500 communicates with the RNC of the UMTS 502. Moreover, when the terminating points of the signaling locate in the nodes of the RATs, it enables operation in multi-vendor environments.

It should also be noted that the particular roles of the RATs in FIG. 5 (3G, UMTS 502 as the second RAT (back-up RAT) and the LTE 500 as the first RAT (applying the inter-eNB ES mode)) are merely implementation examples. The described functionalities/roles may be enabled for any combination and may deploy any of the RATs as the first RAT and any of the RATs as the second RAT. The signaling termination nodes in FIG. 5 may be in the appropriate controlling nodes, such as the eNB for the LTE, the RNC for the UMTS/UTRAN or a BSC for the GSM/GERAN.

As said, the eNB may detect the predetermined condition that allows for the energy saving procedure to be applied. The predetermined condition may be a condition within the first RAT. For example, the predetermined condition may be a predetermined amount of traffic load detected in the first RAT. In other words, when the traffic of the first RAT decreases to a predefined level, the cell of the first RAT may detect that the energy saving procedure is beneficial. Alternative conditions that are detected may include a certain time of the day. For example, the ES procedure may be triggered on automatically each night.

In an embodiment, the eNB may transmit a compensation request 504 to the RNC. The eNB may thus enquire the second radio access technology if it is capable of allocating resources to the at least one user terminal which is handed over in the first handover. Thus, the compensation request is a type of handover request. The compensation request may contain information on how many UEs are to be handed over and/or what is the load to be handed over to the second RAT (for example, the estimated traffic in kilobits may be communicated to the second RAT). As a result, the RNC may have two options for transmitting a compensation response 506. Either to accept the request by responding to the eNB that the second RAT is capable to take part in the handover or to decline the handover request, for example due to insufficient resources. If the response is negative (i.e. second RAT is not able to receive the UEs to be handed over), the first RAT may not perform the handover to the second RAT. In this case the ES mode of the first RAT may not be executed at this point but another enquiry is made later. On the other hand, when the compensation response 506 is positive meaning that the second RAT is capable to allocate resources to the UEs that are to be handed over, the first RAT may perform the first handover 508 after the second radio access technology has confirmed its capability. This may be seen as the beginning of the transition phase from the no-ES mode to the ES-mode of the first RAT. In order to perform the first handover, the second RAT 502 may allocate resources to at least one user terminal which is handed from the first RAT over to the second RAT before at least one cell of the first RAT is temporarily switched off in order to apply an energy saving procedure in the first RAT. Handing UEs over to the second (back-up) RAT 502 ensures a high quality of service with a minimum amount of call drops.

The selection of the UEs to be handed over may depend on the inter-RAT measurements performed by the UEs which are currently served by the first RAT. Thus, only those UEs may be handed over which receive sufficient signal strength from the second RAT. Further criteria may be that only those UEs are handed over which currently locate within the coverage area of a cell that is to be switched off during the ES mode of the first RAT.

After the first handover is performed and before the second handover is triggered on, the LTE 500, as the first RAT which applies the ES mode, may in step 510 switch off the at least one cell in order to save energy in the RAT. Further, the LTE 500 may in step 510 also adapt the at least one cell of the first RAT which at least one cell has not been switched off (compensation cell/eNB 100 in FIG. 1B) in order to provide radio access coverage to the areas of the cells that have been switched off, wherein the adapting comprises changing at least one of the following: transmission power, tilt angle and azimuth angle. That is, the transmission power of the compensation eNB may be increased so that the UEs that are distant from the compensation eNB are capable of receiving sufficient signal strength during the ES mode. The tilt angle as well as the azimuth angle of the antenna pattern may be adapted for the same reasons. It is beneficial to do this adaptation only after the first handover so that the increased transmit power and/or increased tilt do not interfere with the communication links between the other eNBs and UEs that have been handed over to the second RAT in the step 508. As a result, the ES mode is now on: one or more eNB of the first RAT is switched off and the remaining compensation eNBs may have been adapted to the new circumstances within the first RAT. The information that the ES mode in on may be then provided to the second RAT 502 in step 512.

Thereafter, the second handover 514 may be triggered in step 514. That is, the LTE 500 allocates resources to at least one of the at least one user terminal which is handed back from the second RAT to the first RAT in a second handover 514. At this point, the radio access coverage for the first radio access technology is provided by the at least one cell which has not been switched off during step 510. The second RAT 502 may not be able to handover all of the user terminals that were initially handed to the second RAT in the first handover 508. This may be due to insufficient coverage of the ES mode LTE RAT 500 regardless of the adaptation measures performed in step 510, for example. However, in some cases all UEs may be handed back to the first RAT 500. In other words, only at least one (or all) of those UE(s) that were handed to the second RAT in step 508 are now handed back to the first RAT 500 in the second handover 514. The second handover 514 may be seen as the end of the transition phase. This way the second RAT may allocate the released resources to other purposes or keep at least some of the resources reserved for possible further handovers as will be explained next.

In an embodiment, the second RAT 502 may work as a backup RAT in case the first RAT 500 is not, during the ES mode, able to provide sufficient coverage to certain UEs. Thus in this case, the LTE 500 may apply a further handover of certain at least one user terminal from the first RAT to the second RAT when the coverage of the first RAT during the energy saving procedure is insufficient for the certain at least one user terminal. This is beneficial as instead of dropping the ongoing data transfer between the compensation eNB and the certain user terminal, the certain user terminal is handed over to the second RAT which is able to provide sufficient signal strength and services to the certain user terminal.

In an embodiment, in step 516, the second RAT 502 may provide information to the first radio access technology regarding the success of the second handover 514. Such information may indicate that, for example, 90% of the UEs were successfully handed over to the LTE 500, 5% of the UEs ended their calls or suffered from a handoff failure, and 5% of the UEs were remained in the UMTS 502. The exchange of information may happen via signaling between the eNB and the RNC. The eNB may then apply the received information in determining configuration of the following energy saving procedure in step 518, i.e. use the information as input for a self-organizing network (SON) features regarding the future energy saving procedures. The determination of the configuration comprises at least one of the following: determining at least one cell which is to be switched off, determining at least one cell which is not to be switched off, determining how to change the transmission power of the at least one cell which is not to be switched off, and determining how to change the tilt angle of the at least one cell which is not to be switched off. Thus, by knowing the success of the second handover, the LTE 500 may optimize its energy saving procedure so that the success is improved in the later ES procedures. The success is improved when more UEs are successfully handed over to the LTE. Such optimization may include keeping more eNBs as the compensation eNBs, in case coverage is clearly not sufficient in the current LTE ES mode. Alternatively, the number of compensation nodes may be kept the same but the selection of compensation nodes may be so that they are distributed more sparsely in the area so that coverage is improved. Thus, the received information 516 is used as input for the decision on which particular cells are dedicated to ES and which cells are dedicated ES-compensation cells/nodes. Alternatively or in addition to, the adaptation measures, such as the tilt angle and/or radio transmission power, may be further optimized. If it is seen from the received information 516 that the coverage is currently insufficient, the down tilt angle may be decreased and/or the transmission power may be increased. If the current success is already more than sufficient, the number of compensation nodes and/or the transmission power may be decreased. Further, the down tilt angle may be increased, for example. Here down tilt angle (also called a tilt angle) is defined so that a zero angle means horizontal level and X degrees mean X degrees down relative to the horizontal level. Thus, the LTE 500 may perform self-learning and self-adaptation so as to optimize the energy saving procedure for the future (following) ES on situations. This way the risk of severe QoS problems is minimized as the coverage of the ES mode is improved in an optimized manner. Also the UMTS-coverage as the back-up is maintained and it may serve UEs which might temporarily be out-of-LTE coverage regardless of the optimization measures applied in step 518.

The eNB may also apply the knowledge of at least one of the following in the configuration of the following energy saving procedure: the number of handovers between the first and the second radio access technology during the current energy saving procedure, and information from the second radio access technology regarding the coverage of the first radio access technology during the current energy saving procedure. For example, a high number of handovers indicates coverage issues from which the eNB may know that optimization steps as explained above may be needed. The second RAT (UMTS 502) may also provide information regarding the coverage of the first RAT during the ES mode of the first RAT. The second RAT may obtain such information by commanding the UEs served by the second RAT 502 to perform LTE neighbor cell measurements. The UEs then communicate the measured LTE signal strengths to the RNC of the UMTS 502 who may process the data and forward the data or indication of the data to the LTE 500. By knowing the LTE signal strength in different locations of the UMTS cell, the coverage of the LTE may be derived and if seen insufficient, the coverage may be improved by applying the optimization. Insufficient coverage may denote that the LTE cannot serve UEs with sufficient signal strength and/or services. Alternatively or in addition to, the UMTS 502 may obtain information of the coverage of the LTE 500 by measuring the load variation in time of the UMTS 502. A load increase of the UMTS 502 (UTRAN layer) indicates that some UEs may be outside the LTE coverage. This information may also then be communicated to the LTE 500 and the LTE 502 may use it as input for the optimization.

The eNB of the LTE 500 receiving the information may perform the self-learning 518 by itself and distribute the information to other eNBs of the LTE 500 via an X2 interface, for example. Alternatively, the eNB may forward the received data to a centralized unit, such as the O&M, and the centralized unit may perform the optimization process and distribute the data to the eNBs of the LTE 500.

Even though the description has described that the ES mode is applied in the first RAT 500, it is also possible that, in addition, the second RAT employs its own ES mode, such as an intra-RAT (e.g., an inter-RNC) ES procedure.

An embodiment, as shown in FIG. 4, provides an apparatus 400 comprising at least one processor 402 and at least one memory 404 including a computer program code, wherein the at least one memory 404 and the computer program code are configured, with the at least one processor 402, to cause the apparatus 400 to carry out any one of the above-described processes relating to employing the ES mode in the first RAT. It should be noted that FIG. 4 shows only the elements and functional entities required for understanding the apparatus 400. Other components have been omitted for reasons of simplicity. The implementation of the elements and functional entities may vary from that shown in FIG. 4. The connections shown in FIG. 4 are logical connections, and the actual physical connections may be different. The connections can be direct or indirect and there can merely be a functional relationship between components. It is apparent to a person skilled in the art that the apparatus 400 may also comprise other functions and structures.

The apparatus 400 may be comprised in a base station (also called a base transceiver station, a Node B, a radio network controller, or an evolved Node B, for example). The apparatus 400 may comprise a circuitry, e.g. a chip, a processor, a micro controller, or a combination of such circuitries in the base station and cause the base station to carry out the above-described functionalities. In an embodiment, the apparatus 400 performs the required functionalities to carry out the embodiments of the eNB of the LTE 500 of FIG. 5. In another embodiment the apparatus 400 performs the required functionalities to carry out the embodiments of the RNC of the UMTS 500 of FIG. 5.

As said, the apparatus 400 may comprise the at least one processor 402. The at least one processor 402 may be implemented with a separate digital signal processor provided with suitable software embedded on a computer readable medium, or with a separate logic circuit, such as an application specific integrated circuit (ASIC). The at least one processor 402 may comprise an interface, such as computer port, for providing communication capabilities.

The at least one processor 402 may comprise an energy saving circuitry 408. The ES circuitry 410 may, in an embodiment where the apparatus 400 is comprised in a control node of the first RAT, detect a predetermined condition that allows for an energy saving procedure to be applied and temporarily switch off at least one cell of the first radio access technology after the first handover is completed, for example. The energy saving circuitry 408 may also be responsible of performing the optimization measures for the following ES procedures and of performing adaptations of the compensation nodes (change of TX power, tilt). The at least one processor 402 may also comprise a handover circuitry 410 for, in an embodiment where the apparatus 400 is comprised in a control node of the first RAT, triggering the first handover, allocating resources due to the second handover and taking part in any further handovers, for example.

The ES circuitry 410 may, in an embodiment where the apparatus 400 is comprised in a control node of the second RAT, perform its own ES procedures, such as the intra-RAT ES procedure, perform measures that reveal coverage issues of the first RAT, for example. The handover circuitry 410 may, in an embodiment where the apparatus 400 is comprised in a control node of the second RAT, allocate resources of the second radio access technology to at least one user terminal which is handed from the first radio access technology over to the second radio access technology, perform the second handover of at least one of the at least one user terminal from the second radio access technology to the first radio access technology, analyze the success of the second handover, and cause a transmission of handover success message (message 516 of FIG. 5) to the first RAT, for example.

The apparatus 400 may further comprise radio interface components 406 providing the apparatus with radio communication capabilities with the radio access network. The radio interface components 406 may comprise standard well-known components such as amplifier, filter, frequency-converter, (de)modulator, and encoder/decoder circuitries and one or more antennas.

The memory 404 may be for storing data related to the handover success, ES procedures (IDs of compensation cells, tilt values, transmission power, etc.), adaptation and optimization information, etc.

As used in this application, the term ‘circuitry’ refers to all of the following: (a) hardware-only circuit implementations, such as implementations in only analog and/or digital circuitry, and (b) combinations of circuits and software (and/or firmware), such as (as applicable): (i) a combination of processor(s) or (ii) portions of processor(s)/software including digital signal processor(s), software, and memory(ies) that work together to cause an apparatus to perform various functions, and (c) circuits, such as a microprocessor(s) or a portion of a microprocessor(s), that require software or firmware for operation, even if the software or firmware is not physically present. This definition of ‘circuitry’ applies to all uses of this term in this application. As a further example, as used in this application, the term ‘circuitry’ would also cover an implementation of merely a processor (or multiple processors) or a portion of a processor and its (or their) accompanying software and/or firmware. The term ‘circuitry’ would also cover, for example and if applicable to the particular element, a baseband integrated circuit or applications processor integrated circuit for a mobile phone or a similar integrated circuit in a server, a cellular network device, or another network device.

The techniques and methods described herein may be implemented by various means. For example, these techniques may be implemented in hardware (one or more devices), firmware (one or more devices), software (one or more modules), or combinations thereof. For a hardware implementation, the apparatus(es) of embodiments may be implemented within one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a combination thereof. For firmware or software, the implementation can be carried out through modules of at least one chip set (e.g. procedures, functions, and so on) that perform the functions described herein. The software codes may be stored in a memory unit and executed by processors. The memory unit may be implemented within the processor or externally to the processor. In the latter case, it can be communicatively coupled to the processor via various means, as is known in the art. Additionally, the components of the systems described herein may be rearranged and/or complemented by additional components in order to facilitate the achievements of the various aspects, etc., described with regard thereto, and they are not limited to the precise configurations set forth in the given figures, as will be appreciated by one skilled in the art.

Thus, according to an embodiment, the apparatus comprises processing means configured to carry out embodiments of any of the FIGS. 1 to 7. In an embodiment, the at least one processor 402, the memory 404, and the computer program code form an embodiment of processing means for carrying out the embodiments of the invention.

FIG. 6 shows a method according to an embodiment. The method starts in step 600. In step 602, predetermined condition is detected that allows for an energy saving procedure to be applied, wherein the energy saving procedure comprises switching off at least one cell of a first radio access technology. In step 604, the method comprises performing a first handover of at least one user terminal from the first radio access technology to a second radio access technology. In step 606 the at least one cell of the first radio access technology is temporarily switched off after the first handover is completed. In step 608 resources of the first radio access technology are allocated to at least one of the at least one user terminal which is handed back from the second radio access technology to the first radio access technology in a second handover, wherein radio access coverage for the first radio access technology is provided by the at least one cell which has not been switched off. The method ends in step 610.

FIG. 7 shows a method according to an embodiment. The method starts in step 700. The method comprises, in step 702, allocating resources of a second radio access technology to at least one user terminal which is handed from a first radio access technology over to the second radio access technology before at least one cell of the first radio access technology is temporarily switched off in order to apply an energy saving procedure in the first radio access technology, in step 704, performing a second handover of at least one of the at least one user terminal from the second radio access technology to the first radio access technology after the at least one cell of the first radio access technology is temporarily switched off, and in step 706, providing information to the first radio access technology regarding the success of the second handover. The method ends in step 708.

Embodiments as described may also be carried out in the form of a computer process defined by a computer program. The computer program may be in source code form, object code form, or in some intermediate form, and it may be stored in some sort of carrier, which may be any entity or device capable of carrying the program. For example, the computer program may be stored on a computer program distribution medium readable by a computer or a processor. The computer program medium may be, for example but not limited to, a record medium, computer memory, read-only memory, electrical carrier signal, telecommunications signal, and software distribution package, for example.

Even though the invention has been described above with reference to an example according to the accompanying drawings, it is clear that the invention is not restricted thereto but can be modified in several ways within the scope of the appended claims. Therefore, all words and expressions should be interpreted broadly and they are intended to illustrate, not to restrict, the embodiment. It will be obvious to a person skilled in the art that, as technology advances, the inventive concept can be implemented in various ways. Further, it is clear to a person skilled in the art that the described embodiments may, but are not required to, be combined with other embodiments in various ways.

1. A method, comprising:
detecting a predetermined condition that allows for an energy saving procedure to be applied, wherein the energy saving procedure comprises switching off at least one cell of a first radio access technology;
performing a first handover of at least one user terminal from the first radio access technology to a second radio access technology;
temporarily switching off the at least one cell of the first radio access technology after the first handover is completed; and
allocating resources of the first radio access technology to at least one of the at least one user terminal which is handed back from the second radio access technology to the first radio access technology in a second handover, wherein radio access coverage for the first radio access technology is provided by the at least one cell which has not been switched off.

2. The method of claim 1, further comprising:
adapting, before the second handover is performed, the at least one cell of the first radio access technology which has not been switched off in order to provide radio access coverage to the area of the cells that have been switched off, wherein the adapting comprises changing at least one of the following: transmission power, tilt angle and azimuth angle.

3. The method of claim 1, further comprising:
enquiring the second radio access technology if it is capable of allocating resources to the at least one user terminal which is handed over in the first handover; and
performing the first handover after the second radio access technology has confirmed its capability.

4. The method of claim 1, further comprising:
receiving information from the second radio access technology regarding the success of the second handover; and
applying the received information in determining configuration of the following energy saving procedure.

5. The method of claim 4, wherein the determination of the configuration comprises at least one of the following: determining at least one cell which is to be switched off, determining at least one cell which is not to be switched off, determining how to change the transmission power of the at least one cell which is not to be switched off, and determining how to change the tilt angle of the at least one cell which is not to be switched off.

6. The method of claim 4, further comprising:
applying the knowledge of at least one of the following in the configuration of the following energy saving procedure: the number of handover between the first and the second radio access technology during the current energy saving procedure, and information from the second radio access technology regarding the coverage of the first radio access technology during the current energy saving procedure.

7. The method of claim 1, further comprising:
performing a further handover of certain at least one user terminal from the first radio access technology to the second radio access technology when the coverage of the first radio access technology during the energy saving procedure is insufficient for the certain at least one user terminal.

8. A method, comprising:
allocating resources of a second radio access technology to at least one user terminal which is handed from a first radio access technology over to the second radio access technology before at least one cell of the first radio access technology is temporarily switched off in order to apply an energy saving procedure in the first radio access technology;
performing a second handover of at least one of the at least one user terminal from the second radio access technology to the first radio access technology after the at least one cell of the first radio access technology is temporarily switched off; and providing information to the first radio access technology regarding the success of the second handover.

9. The method of claim 8, further comprising:
providing further information regarding the coverage of the first radio access technology during the energy saving procedure.

10. An apparatus, comprising:
at least one processor and at least one memory including a computer program code, wherein the at least one memory and the computer program code are configured to, with the at least one processor, cause the apparatus at least to:
detect a predetermined condition that allows for an energy saving procedure to be applied, wherein the energy saving procedure comprises switching off at least one cell of a first radio access technology;
perform a first handover of at least one user terminal from the first radio access technology to a second radio access technology;
temporarily switch off the at least one cell of the first radio access technology after the first handover is completed; and
allocate resources of the first radio access technology to at least one of the at least one user terminal which is handed back from the second radio access technology to the first radio access technology in a second handover, wherein radio access coverage for the first radio access technology is provided by the at least one cell which has not been switched off.

11. The apparatus of claim 10, wherein the apparatus is further caused to:
adapt, before the second handover is performed, the at least one cell of the first radio access technology which has not been switched off in order to provide radio access coverage to the area of the cells that have been switched off, wherein the adapting comprises changing at least one of the following: transmission power, tilt angle and azimuth angle.

12. The apparatus of claim 10, wherein the apparatus is further caused to:
enquire the second radio access technology if it is capable of allocating resources to the at least one user terminal which is handed over in the first handover; and
perform the first handover after the second radio access technology has confirmed its capability.

13. The apparatus of claim 10, wherein the apparatus is further caused to:
receive information from the second radio access technology regarding the success of the second handover; and
apply the received information in determining configuration of the following energy saving procedure.

14. The apparatus of claim 13, wherein the determination of the configuration comprises at least one of the following: determining at least one cell which is to be switched off, determining at least one cell which is not to be switched off, determining how to change the transmission power of the at least one cell which is not to be switched off, and determining how to change the tilt angle of the at least one cell which is not to be switched off.

15. The apparatus of claim 13, wherein the apparatus is further caused to:
apply the knowledge of at least one of the following in the configuration of the following energy saving procedure: the number of handover between the first and the second radio access technology during the current energy saving procedure, and information from the second radio access technology regarding the coverage of the first radio access technology during the current energy saving procedure.

16. The apparatus of claim 10, wherein the apparatus is further caused to:
perform a further handover of certain at least one user terminal from the first radio access technology to the second radio access technology when the coverage of the first radio access technology during the energy saving procedure is insufficient for the certain at least one user terminal.

17. An apparatus, comprising:
at least one processor and at least one memory including a computer program code, wherein the at least one memory and the computer program code are configured to, with the at least one processor, cause the apparatus at least to:
allocate resources of a second radio access technology to at least one user terminal which is handed from a first radio access technology over to the second radio access technology before at least one cell of the first radio access technology is temporarily switched off in order to apply an energy saving procedure in the first radio access technology;
perform a second handover of at least one of the at least one user terminal from the second radio access technology to the first radio access technology after the at least one cell of the first radio access technology is temporarily switched off; and
provide information to the first radio access technology regarding the success of the second handover.

18. The apparatus of claim 17, wherein the apparatus is further caused to:
provide further information regarding the coverage of the first radio access technology during the energy saving procedure.

19. (canceled)

20. A computer program product embodied on a distribution medium readable by a computer and comprising program instructions which, when loaded into an apparatus, execute the method according to claim 1.

21. A computer program product embodied on a distribution medium readable by a computer and comprising program instructions which, when loaded into an apparatus, execute the method according to claim 8.
